(19) United States
(12) Patent Application Publication
(10) Pub. No.: US 2021/0143923 A1
(43) Pub. Date: May 13, 2021

(54) SYSTEM AND METHOD FOR MONITORING AND MAPPING SIGNAL STRENGTH

(71) Applicant: Plano Molding Company, LLC, Plano, IL (US)

(72) Inventors: Ryan KLECKNER, Grand Prairie, TX (US); Raymond DIKUN, Grand Prairie, TX (US); James HYMEL, Grand Prairie, TX (US)

(21) Appl. No.: 17/092,926

(22) Filed: Nov. 9, 2020

Related U.S. Application Data
(60) Provisional application No. 62/934,130, filed on Nov. 12, 2019.

(51) Int. Cl. H04B 17/318; H04W 24/08; H04W 4/029; G06N 3/08

(52) U.S. Cl. CPC H04B 17/318; G06N 3/08; H04W 4/029; H04W 24/08

(57) ABSTRACT

A signal strength mapping solution that can detect, identify or log signal strength data for a plurality of locations and transmit a signal strength data signal to a remote communication device. The mobile communication device can be arranged to detect or determine, and log or store signal strength information, including signal strength as a function of time, geographic location and/or ambient conditions. The mobile communication device can be arranged to render a signal coverage map that includes a recommended location for optimal connectivity of the communication device in a geographic area.

### CROSS-REFERENCE TO PRIOR APPLICATION

The present application claims the benefit of and priority to provisional U.S. Patent Application No. 62/934,130, filed on Nov. 12, 2019, titled, “System and Method for Monitoring and Mapping Signal Strength,” which is hereby incorporated herein by reference in its entirety, as if fully set forth herein.

### FIELD OF THE DISCLOSURE

The disclosure relates generally to a method, system and computer program for monitoring, logging and mapping signal strength in a geographic area.

### BACKGROUND OF THE DISCLOSURE

In many geographic areas, network connectivity can be a serious problem. If a transceiver is placed in an area of poor coverage, it can be difficult or impossible to get sufficient connectivity between the transceiver and a nearby network, such as, for example, a local area network (LAN) or a wide area network impossible. An unmet need exists for a solution that can facilitate determination of signal strength and signal coverage to allow an end user to determine if they are in the area of best coverage and, if not, to identify potentially better coverage areas for the transceiver.

### SUMMARY OF THE DISCLOSURE

This disclosure provides a novel solution that meets those needs, as well as others. The solution comprises a system, method and a computer program arranged to log and map signal strength in a geographic area.

According to a non-limiting embodiment of the disclosure, a system is provided for determining optimal placement of a communication device in a geographic area. The system comprises a transceiver arranged to receive a signal strength data signal from a communication device located in the geographic area, a data parser arranged to parse signal strength value data and positional data from signal strength data in the signal strength data signal, a signal mapping unit arranged to analyze the signal strength value data and positional data and predict an optimal connectivity location in the geographic area, and a coverage map generator arranged to generate and transmit a signal coverage map rendering instruction and data signal to the communication device. The system can comprise a database arranged to store a communication signal strength mapper (CSSM) record for each positional data value. The communication device can comprise a smartphone or computer tablet.

In the system, the signal strength value can comprise a received signal strength indicator (RSSI) value that is determined by the communication device.

In the system, the signal mapping unit can comprise a neural network.

In the system, the signal mapping unit can be arranged to analyze historical signal strength data based on the positional data.

In the system, the positional data value can comprise global positioning system (GPS) coordinates for a location in the geographic area.

According to another non-limiting embodiment of the disclosure, a method is provided for determining a location in a geographic area for optimal connectivity or placement of a communication device. The method comprises receiving, by the communication device, a communication signal from a transmitting antenna; determining, by the communication device, a signal strength value of the received communication signal at a first location in the geographic area; determining, by the communication device, positional data for the first location; transmitting, by the communication device, the signal strength value and positional data to a remote communication device; receiving, by the communication device, a signal coverage map instruction and data signal from the remote communication device; and rendering, by the communication device, a signal coverage map for the geographic area on a display device, wherein the signal coverage map includes a predicted location in the geographic area for optimal connectivity of the communication device.

According to another non-limiting embodiment of the disclosure, a method is provided for determining a location in a geographic area for optimal connectivity or placement of a communication device. The method comprises receiving, by a transceiver, a signal strength data signal from the communication device; parsing, by a data parser, signal strength value data and positional data from signal strength data in the signal strength data signal; analyzing, by a signal mapping unit, the signal strength value data and positional data; predicting, by the signal mapping unit, the location in the geographic area for optimal connectivity of the communication device; generating, by a coverage map generator, a signal coverage map rendering instruction and data signal; and transmitting, by the transceiver, the signal coverage map rendering instruction and data signal to the communication device, wherein the signal coverage map rendering instruction and data signal includes positional data for a predicted location in the geographic area for optimal connectivity of the communication device.

According to another non-limiting embodiment of the disclosure, a non-transitory computer-readable storage medium is provided storing computer program instructions for determining a location in a geographic area for optimal connectivity or placement of a communication device. When executed on a processor, the program instructions cause the processor to carry out the steps of: receiving, by the communication device, a communication signal from a transmitting antenna; determining, by the communication device, a signal strength value of the received communication signal at a first location in the geographic area; determining, by the communication device, positional data for the first location; transmitting, by the communication device, the signal strength value and positional data to a remote communication device; receiving, by the communication device, a signal coverage map instruction and data signal from the remote communication device; and rendering, by the communication device, a signal coverage map for the geographic area on a display device, wherein the signal coverage map includes a predicted location in the geographic area for optimal connectivity of the communication device.

According to another non-limiting embodiment of the disclosure, a non-transitory computer-readable storage medium is provided storing computer program instructions for determining a location in a geographic area for optimal connectivity or placement of a communication device. The program instructions, when executed by a processor, cause the processor to carry out the steps of: receiving, by a transceiver, a signal strength data signal from the communication device; parsing, by a data parser, signal strength value data and positional data from signal strength data in the signal strength data signal; analyzing, by a signal mapping unit, the signal strength value data and positional data; predicting, by the signal mapping unit, the location in the geographic area for optimal connectivity of the communication device; generating, by a coverage map generator, a signal coverage map rendering instruction and data signal; and transmitting, by the transceiver, the signal coverage map rendering instruction and data signal to the communication device, wherein the signal coverage map rendering instruction and data signal includes positional data for a predicted location in the geographic area for optimal connectivity of the communication device.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a non-limiting example of a reduced signal strength environment provided with a signal strength mapping (SSM) system, constructed according to the principles of the disclosure.

FIG. 2 shows a non-limiting embodiment of the signal strength mapping (SSM) system, constructed according to the principles of the disclosure.

FIG. 3 shows a non-limiting embodiment of a communication signal strength mapper (CSSM) that can be included in SSM system shown in FIG. 2.

FIG. 4 shows a non-limiting example of a signal coverage map rendered on a display of a communication device in the SSM system shown in FIG. 2.

FIG. 5 shows an example of the signal coverage map rendered on the display of the communication device in the SSM system shown in FIG. 2, including the environment shown in FIG. 1.

FIG. 6 shows another non-limiting example of a signal coverage map rendered on the display of the communication device in the SSM system shown in FIG. 2.

FIG. 7 shows a non-limiting example of a signal coverage mapping process that can be carried out by the SSM system shown in FIG. 2.

The present disclosure is further described in the detailed description and drawings that follows.

### DETAILED DESCRIPTION OF THE DISCLOSURE

The embodiments of the disclosure and the various features and advantageous details thereof are explained more fully with reference to the non-limiting embodiments and examples that are described or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated. Descriptions of well-known components and processing techniques can be omitted so as to not unnecessarily obscure the embodiments of the disclosure. The examples are intended merely to facilitate an understanding of ways in which the disclosure can be practiced and to further enable those of skill in the art to practice the embodiments of the disclosure. Accordingly, the examples and embodiments should not be construed as limiting the scope of the disclosure, which is defined solely by the appended claims and applicable law. Moreover, it is noted that like reference numerals represent similar parts throughout the several views of the drawings.

Currently, wireless communication systems typically use a network and one or more communication links to facilitate transmission of communication signals between remotely located communication devices—that is, located at different geographic locations. Networks, including, for example, cellular networks, local area networks (LANs), wide area networks (WANs), metropolitan area network (MANs), personal area network (PANs), campus area networks (CANs), corporate area network, enterprise networks, global area networks (GANs), broadband area network (BANs) or the Internet, are ubiquitous and tend to be distributed globally. The remotely located communication devices can each include a transceiver that can be used for transmission or reception of communication signals, including, for example, audio, video, text, computer executable code, or any other type of data or instruction signals. In the case of a cellular network, each cell in the network may use different frequencies from neighboring cells to avoid interference and provide quality of service (QoS). Similarly, LANs or WANs can operate on communication links having different frequencies or bandwidths.

Signal strength in communication systems generally refers to a transmitter power output as received by a communication device located at a distance from a transmitting antenna. From the vantage point of the mobile communication device, the signal strength of a signal received from the transmitter will depend on the location of the transmitting antenna and its distance from the mobile communication device, the topography surrounding the mobile communication device or the transmitting antenna, and the power output of the transmitter. The signal strength can depend on ambient conditions, among other things, such as, for example, precipitation or cloud cover.

Although ubiquitous globally, there are still many geographic areas that have inadequate or nonexistent network coverage. Some rural areas are unlikely to ever be covered effectively because of the cost associated with installing equipment such as, for example, cell site transceivers. For instance, certain mountainous regions in many states in the United States of America are unlikely to ever be covered effectively, since the regions are rarely visited by humans and installation of equipment such as cell towers may be undesirable, unwanted, unwarranted or unjustifiable. Such regions, however, may be visited by outdoor enthusiasts, hikers, climbers, animal researchers, animal watchers, fishermen, and hunters, who, compared to the general public, disproportionately visit or stay at such locations. The inventors have found that there exists an unmet need for providing such visitors with a signal strength mapping solution that can identify optimal geographic locations for placement or use of communication devices in poor coverage areas.

The instant disclosure provides a system and method for detecting signal strength, identifying or logging signal strength data for each of a plurality of geographic locations, and transmitting a signal strength data signal to a remote communication device, such as, for example, an embedded communication device 10 (shown in FIGS. 1 and 2), a mobile communication device 40 (shown in FIG. 2) or a communication signal strength mapper 90 (shown in FIG. 2). The signal strength data signal can be generated or transmitted by one or more embedded communication devices (ECDs) 10 or mobile communication devices (MCDs) 40. One or more of the communication devices 10, 40 can be arranged to detect or determine, and log or store signal strength information, including signal strength as a function of time, geographic location and ambient conditions. The signal strength data can include a frequency value for each signal detected by the communication device 10, 40.

In a non-limiting embodiment, the ECDs 10 and MCD 40 can be substantially identical in hardware and/or software.

The frequency data can be used by the ECD 10, MCD 40, or CSSM 90 to identify the communication device from which the signal originated (for example, the signal source). Referring to FIG. 2, each of the four ECDs 10 in this non-limiting example can be configured to communicate with each other and/or with the MCD 40 over a communication link having a distinct frequency or time slot. The MCD 40 can be configured to measure and log the signal strength, as well as the positional data for each of the four distinct frequencies (or time slots) and the respective ECDs 10 that transmitted the signals.

In a non-limiting embodiment, a signal strength mapping (SSM) system 5 (shown in FIG. 2) can be arranged to parse and process received signal strength data signals, including signal strength values and position data for the ECDs 10 or MCDs 40. The system 5 can be arranged to generate coverage map rendering instruction and data signals (“signal coverage map signals”). The signal coverage map signals can be transmitted to the MCD 40 (shown in FIG. 2) to render a signal coverage map on a display device. The signal coverage map signal can include a placement recommendation instruction that, when executed by the MCD 40 (shown in FIG. 2), can cause the communication device to display a recommendation for placement of an ECD 10 (shown in FIG. 2) in a geographic area for optimal connectivity to a transceiver site 70 (shown in FIG. 2), an ECD 10 (shown in FIG. 2) or another MCD (not shown). The transceiver site 70 can include, for example, a cellular tower, a cellular signal transceiver, a wireless access point (WAP), or a satellite transceiver, a radio station, or any other device or location capable of transmitting or receiving an electromagnetic (EM) or radio frequency (RF) signal.

FIG. 1 shows a non-limiting example of a reduced signal strength environment 1 provided with an embodiment of the signal strength mapping (SSM) system 5 (shown in FIG. 2), according to the principles of the disclosure. The environment 1 can include a geographic area where a user may wish to enter, stay or traverse, or where the user may wish to place one or more ECDs 10 to observe, view, track or monitor an animal as it enters, stays or traverses the area, such as, for example, in animal research, animal observation, or hunting applications. The signal strength mapping system 5 can include one or more ECDs 10. The environment 1 can include one or more objects 20 to which an ECD 10 can be attached. The environment 1 can include a trail 30 that may be used by an animal or user when entering, traversing or leaving the area. One or more of the ECDs 10 can be positioned for optimal performance in the area, including, for example, optimal signal strength or optimal viewing of an animal or geographic location with sufficient signal strength for quality of service (QoS).

FIG. 2 shows a non-limiting embodiment of the signal strength mapping (SSM) system 5, constructed according to the principles of the disclosure. The SSM system 5 can include one or more ECDs 10. The SSM system 5 can include the MCD 40. The SSM system 5 can include a communication signal strength mapper (CSSM) 90. The components, including, for example, ECD 10, MCD 40 and CSSM 90, can be interconnected or connected to other communication devices (not shown) via one or more communications links.

The CSSM 90 can be located in a computer network 50, such as, for example, a LAN, a WAN, or a cloud computer network (for example, in the Internet). The CSSM 90 can be arranged to interact directly or indirectly with the MCD 40 or ECD 10 over one or more communication links. The CSSM 90 can be accessible through the computer network 50. The CSSM 90 can be arranged to exchange data or instruction signals with the ECD 10 or the MCD 40 over one or more communication links. The ECD 10 or MCD 40 can be arranged to communicate data or instruction signals to the CSSM 90 via the transceiver site 70.

The MCD 40 can include a smartphone, tablet, or other portable communication device. The MCD 40 can include, for example, an iPHONE® or iPAD®. Data and instruction signals can be exchanged between the MCD 40 and each ECD 10 over one or more communication links, or by means of a device (not shown), such as, for example, a secure digital (SD) card reader, SD card, flash drive or other removal storage device. Signal strength values measured and/or logged by the ECD 10 can be transmitted to the MCD 40 via the communication link(s) or the removal storage device (not shown), which can be arranged to be removed from the ECD 10 and connected to the MCD 40 to download the measured or logged signal strength data to the MCD 40.

Alternatively, one or more of the ECDs 10 can transmit signal strength data measured and/or logged by the ECD(s) directly to the CSSM 90. The signal strength data can be transmitted to the CSSM by the ECD 10 over one or more communication links via, for example, the transceiver site 70 and/or the network 50.

The ECD 10 can include one or more sensors that can measure ambient conditions, including, for example, weather conditions, or receive ambient condition data for the geographic location of the ECD 10 from an external data source (such as, for example, a weather service website). The ambient conditions can include, for example, temperature, pressure, humidity, precipitation, rate of precipitation, wind, wind speed, wind direction, light level, or sun/cloud conditions for the geographic location.

The ECD 10 can include a camera device, such as, for example, a wireless trail camera or a three-dimensional (3D) color-depth (RGBD) camera that can be attached to a tree or other object. The ECD 10 can include an Internet-of-Things (IoT) device such as an IOT camera. The ECD 10 can include a global positioning system (GPS) receiver or other geographic location determination device, as understood by those skilled in the art. The ECD 10 can include a transceiver (transmitter and receiver) that can transmit or receive WiFi, BlueTooth, cellular, satellite, radio frequency (RF), infrared (IR), or any other type of communication signal.

The ECD 10 can be arrange to measure, monitor or store information about the signal strength of a received communication signal, ambient conditions, time data, and positional data (including, geographic location data such as GPS coordinates) as a function of time. The ECD 10 can be arranged to record signal strength information, ambient conditions and geographic locations over time, which can include positional data as the device is moved over time. The communication signal can be received by the ECD 10 from, for example, the MCD 40, the transceiver site 70 or another ECD 10.

The signal strength information can include, for example, a received signal strength indicator (RSSI) value that is determined by the MCD 40 from the intermediate frequency (IF) of the received baseband signal. The MCD 40 can be configured to include a logging mode that, when selected by, for example, a user, can cause the device to determine and log RSSI values in conjunction with positional data as the MCD 40 moves between two or more geographic locations, which can then be transmitted to the CSSM 90 to generate a coverage map with a recommendation on placement for optimally connectivity in a geographic area.

The MCD 40 can be arranged to aggregate and transmit the signal strength information (for example, RSSI values), ambient condition data, time data and/or positional data as the signal strength data signal. The MCD 40 can transmit the signal strength data signal to the CSSM 90 via the transceiver site 70 or to another MCD (not shown) or ECD 10 directly via one or more communication links.

The MCD 40 can be configured as a hotspot for the ECDs 10 or other MCDs (not shown).

An ECD 10 can be configured as a hotspot for other ECDs 10 or the MCD 40.

FIG. 3 shows a non-limiting embodiment of the CSSM 90, constructed according to the principles of the disclosure. The CSSM 90 can include a server. The CSSM 90 can include a graphic processor unit (GPU) 110, a storage 120, a network interface 130, an input-output (I/O) interface 140, a user profile manager 150, a database 160, a signal mapping unit 170, and a coverage map generator 180. The CSSM 90 can receive a signal strength data signal from the MCD 40 (shown in FIG. 2) and separate out signal strength data from the signal, which can be parsed by the CSSM into, for example, RSSI values and positional data. The CSSM 90 can be configured to parse out ambient condition data from the received signal strength data signal. Based on the signal strength data, the CSSM 90 can generate a signal coverage map for a geographic area.

The geographic area can be determined by the CSSM 90 based on the positional data or one or more geographic locations selected by a user on the MCD 40 (shown in FIG. 2) and received as an instruction signal with the received signal strength data, or separately, such as a standalone signal. The instruction signal can include, for example, GPS coordinate data for one or more geographic locations and/or a radius value that can be used by the CSSM 90 to define a geographic area that comprises all geographic locations within a radius of a selected geographic location. The radius can be user-definable, such as, for example, using the MCD 40 (shown in FIG. 2), and the radius can have any shape or size.

The CSSM 90 can be arranged to generate coverage map rendering instructions and data (“signal coverage map”) and transmit the signal coverage map to the MCD 40 to render and display a coverage map on its display device (for example, shown in FIGS. 4-6). The signal coverage map can include a placement recommendation that, when executed by the MCD 40, can cause the MCD 40 to render a recommendation on placement for optimal connectivity of the MCD 40 (or an ECD 10) to the transceiver site 70 (shown in FIG. 2). The recommendation can include a recommended placement for each of the ECDs 10 and/or MCD 40 for optimal connectivity, including precise geospatial coordinates, such as, for example, latitude, longitude and height relative to an ellipsoidal Earth model.

The CSSM 90 can include a non-transitory computer-readable medium that can hold executable or interpretable computer code (or instructions) that, when executed by one or more of the components (for example, the GPU 110), cause the steps, processes and methods described in this disclosure to be carried out. The computer-readable medium can be included in the storage 120, or an external computer-readable storage medium connected to the CSSM 90 via the network interface 130 or the I/O interface 140.

The GPU 110 can include any of various commercially available graphic processors, processors, including for example, a central processing unit (CPU), a graphic processing unit (GPU), a general-purpose GPU (GPGPU), a field programmable gate array (FGPA), an application-specific integrated circuit (ASIC), a many core processor, multiple microprocessors, or any other computing device architecture. The GPU 110 can be arranged to interact with each of the components in the CSSM 90.

A basic input/output system (BIOS) can be stored in a non-volatile memory in the CSSM 90, such as, for example, in the storage 120. The BIOS can contain the basic routines that help to transfer information between computing resources within the CSSM 90, such as during start-up.

The storage 120 can include a read-only memory (ROM), a random-access memory (RAM), a hard disk drive (HDD), an optical disk drive (ODD), or a database (DB). The storage 120 can provide nonvolatile storage of data, data structures, and computer-executable instructions, and can accommodate the storage of any data in a suitable digital format.

The ROM can include, for example, an erasable programmable read-only memory (EPROM) or, an electrically erasable programmable read-only memory (EEPROM).

The RAM can include, for example, a non-volatile random-access memory (NVRAM), a burst buffer (BB), a dynamic random access memory (DRAM), a synchronous dynamic random access memory (SDRAM), a static random access memory (SRAM), or another high-speed RAM for caching data.

The HDD can include, for example, an enhanced integrated drive electronics (EIDE) drive, a serial advanced technology attachments (SATA) drive, or any suitable hard disk drive for use with big data. The HDD can be configured for external use in a suitable chassis (not shown). The HDD can be arranged to connect to the bus B via a hard disk drive interface (not shown). The hard disk drive interface (not shown) can include a Universal Serial Bus (USB) (not shown) or an IEEE 1394 interface (not shown) for external applications.

The ODD can be arranged to read or write from or to a compact disk (CD)-ROM disk (not shown), or, read from or write to other high capacity optical media such as a digital versatile disk (DVD). The ODD can be connected to the bus B by an optical drive interface (not shown).

The DB can be arranged to be accessed by any one or more of the components in the CSSM 90. The DB can be arranged to receive a query and, in response, retrieve specific data, data records or portions of data records based on the query. A data record can include, for example, a file or a log. The DB can include a database management system (DBMS) that can interact with the components in the CSSM 90. The DBMS can include, for example, SQL, NoSQL, MySQL, Oracle, Postgress, Access, or Unix. The DB can include a relational database.

A variety of program modules can be stored in the storage 120, including an operating system (not shown), one or more application programs (not shown), application program interfaces (APIs) (not shown), program modules (not shown), or program data (not shown). Any (or all) of the operating system, application programs, APIs, program modules, or program data can be cached in the storage 120 as executable sections of computer code.

The network interface 130 can be connected to the network 50 or one or more external networks (not shown). The network interface 130 can include a wired or a wireless communication network interface (not shown) or a modem (not shown). When communicating in a LAN, the CSSM 90 can be connected to the LAN through the wired or wireless communication network interface; and, when communicating in a WAN, the CSSM 90 can be connected to the WAN through the modem. The modem (not shown) can be internal or external and wired or wireless. The modem can be connected to the backbone B via, for example, a serial port interface (not shown).

The I/O interface 140 can receive commands and data from, for example, an operator via a user interface device (not shown), such as, for example, a keyboard (not shown), a mouse (not shown), a pointer (not shown), a microphone (not shown), a speaker (not shown), or a display (not shown). The received commands and data can be forwarded to the GPU 110, or one or more of the components 120 through 180 as instruction or data signals via the backbone B.

The I/O interface 140 can include a transmitter and receiver (transceiver) that can transmit/receive communication signals from/to an external source, such as, for example, the ECD 10, MCD 40, or transceiver site 70 (shown in FIG. 2).

The network interface 130 can include a data parser (not shown) or the data parsing operation can be carried out by the GPU 110. Received signal mapping data (for example, from the MCD 40 or ECD 10, shown in FIG. 2) can be transferred from the network interface 130 to the GPU 110, database 160, signal mapping unit 170 or coverage map generator 180. The network interface 130 can facilitate communication between any one or more of the components in the CSSM 90 and computing resources located internal (or external) to the network 50. The network interface 130 can handle a variety of communication or data packet formats or protocols, including conversion from one or more communication or data packet formats or protocols used by the ECDs 10 or MCD 40 to the communication or data packet formats or protocols used in the CSSM 90.

The user profile manager 150 can include a computing device or it can be included in a computing device as a module. The user profile manager 150 can create, manage, edit, or delete a communication signal strength management (CSSM) record for each user, MCD 40 or ECD 10 (shown in FIG. 2), including, for example, a user identification, an email address, a user name, a media access control (MAC) address, an Internet Protocol (IP) address, a device serial number, a device name, or any other user or device identification data. The user profile manager 150 can interact with the database 160 to search, retrieve, edit or store CSSM records in the database 160. The user profile manager 150 can manage and link multiple user profiles to enable group or individual-to-individual sharing of information between MCD 40 and one or more other MCDs (not shown), including coverage map data or position data.

The database 160 can include one or more relational databases. The database 160 can include CSSM records for each user, MCD 40 or ECD 10 that has accessed or may be given access to the SSM system 5 (shown in FIG. 2) or CSSM 90. The CSSM records can include historical signal strength data (including, for example, RSSI values and/or positional data) for each MCD 40 and ECD 10, including all geographic locations visited by the MCD 40 or ECD 10 at which a signal strength was measured or determined for the location. Each CSSM record can include geospatial coordinates for each signal strength measurement, time when the signal strength was measured, and identification of the ECD 10 or MCD 40 that measured the signal strength. The CSSM record can include weather conditions when the signal strength was measured, such as, for example, temperature, air pressure, wind direction, wind speed, humidity, precipitation, cloud cover, or any other information that might be useful in determining signal strength at a geographic location.

The signal mapping unit 170 can include one or more computing devices or it can be included in a computing device as one or more modules. The signal mapping unit 170 can be integrated with the coverage map generator 180 in one or more computing devices or as multiple modules in a single computing device. The signal mapping unit 170 and/or coverage map generator 180 can include a machine learning system, such as, for example, a supervised machine learning platform or an unsupervised machine learning platform. The machine learning system can include, for example, a Word2vec deep neural network, a convolutional architecture for fast feature embedding (CAFFE), an artificial immune system (AIS), an artificial neural network (ANN), a convolutional neural network (CNN), a deep convolutional neural network (DCNN), region-based convolutional neural network (R-CNN), you-only-look-once (YOLO), a Mask-RCNN, a deep convolutional encoder-decoder (DCED), a recurrent neural network (RNN), a neural Turing machine (NTM), a differential neural computer (DNC), a support vector machine (SVM), a deep learning neural network (DLNN), Naive Bayes, decision trees, logistic model tree induction (LMT), NBTree classifier, case-based, linear regression, Q-learning, temporal difference (TD), deep adversarial networks, fuzzy logic, K-nearest neighbor, clustering, random forest, rough set, or any other machine intelligence platform capable of supervised or unsupervised learning. The machine learning system can include a machine learning (ML) model that can monitor, log and predict optimal signal strength locations.

The signal mapping unit 170 can be arranged to parse signal strength values and positional data from the received signal strength data. The signal strength values can include RSSI values for each geographic location in the positional data. The signal strength values can vary as a function of time for a geographic location. The signal mapping unit 170 can be arranged to parse time data (for example, a timestamp) for each time a signal strength measurement was taken at each geographic location. The signal mapping unit 170 can be arranged to determine and track signal strength values at each of a plurality of locations over time, including all geographic locations where the MCD 40 or ECD 10 (shown in FIG. 2) measured a signal strength. The signal mapping unit 170 can be arranged to determine and track a frequency value for each signal strength value and/or geographic position. The signal mapping unit 170 can be arranged to analyze historical signal strength data in CSSM records, such as, for example, signal strength values (for example, RSSI values) for each location in a geographic area over time. The signal mapping unit 170 can be arranged to analyze historical frequency data for each location in the geographic area over time.

Based on historical signal strength data included in, for example, CSSM records stored in the database 160, the signal mapping unit 170 can predict signal strength values for each location in a geographic area and recommend a location for placement of an ECD 10 (or MCD 40, shown in FIG. 2) for optimal connectivity in a poor connectivity environment. The signal mapping unit 170 can analyze historical signal strength data for each location and/or frequency in the geographic area and predict a signal strength value for the location and/or frequency. The signal mapping unit 170 can forward the predicted signal strength values for all locations in the geographic area to the coverage map generator 180.

In a non-limiting embodiment, the signal mapping unit 170 can include a neural network (NN) or deep neural network (DNN). The neural network can be trained using a training dataset comprising real signal strength data acquired from a plurality of MCDs and ECDs over time and a test dataset. The training dataset can be built, for example, through interaction with a user by supplying the user with large datasets and receiving annotations for each record in the dataset. The training dataset and testing data set can be used to train the machine learning (ML) model in the signal mapping unit 170 (or coverage map generator 80) and update parametric values in the ML model. The ML model can be updated or fine-tuned based on new, real-time signal strength data received from MCDs or ECDs at the same or nearby geographic locations as historical data used to train the model.

The coverage map generator 180 can interact with the user profile manager 150, database 160, or signal mapping unit 170 and generate coverage map rendering instruction and data signals (“signal coverage map signals”) for the geographic area. The coverage map generator 180 can interact with the MCD 40 (or ECD 10, shown in FIG. 2) to change or modify the geographic area in response to a command signal received from the MCD 40 (or ECD 10), which can be transmitted in response to a user entry on the device, such as, for example, selection, addition, deletion or change in one or more locations in the geographic area, or the entire area. The signal coverage map signals can include one or more recommended locations for placement of the ECD 10 (or MCD 40, shown in FIG. 2). The signal coverage map signals can be transmitted to the MCD 40 via, for example, the network interface 130 or I/O interface 140 over a communication link, which can include the transceiver site 70.

The signal coverage map signal, which can include a placement recommendation, can be received at the MCD 40 (shown in FIG. 2). The MCD 40 can demodulate the signal and parse out coverage map rendering instruction and data signals. Upon executing the coverage map rendering instruction signal, the MCD 40 can generate and render a signal strength map and populate the map using the coverage map rendering data on its display device, as shown, for example, in FIGS. 4-6. The displayed coverage map can include actual and/or predicted signal strength values for each location in the geographic area displayed on the MCD 40. The displayed coverage map can include an image such as, for example, a pin that can be dropped on a location for optimal connectivity in the area.

Referring to FIGS. 4-6, using the MCD 40, a user can retrieve (for example, from the CSSM 90, shown in FIGS. 2 and 3) and display signal coverage maps based on one or more geographic locations. Via the MCD 40, the user can change the shape, size or location(s) of the geographic area. Additionally, the user can share (via the MCD 40) signal coverage maps with groups or individuals equipped with similar communication devices (not shown).

FIG. 7 shows a non-limiting embodiment of a signal coverage mapping process 200 that can be carried out by the CSSM 90 (shown in FIG. 2 or 3), and, more specifically, the GPU 110 (shown in FIG. 3).

Referring to FIGS. 1-3, 5 and 7, a user equipped with the MCD 40 (shown in FIG. 2) can move through the environment 1 with poor connectivity (shown in FIG. 1). If equipped with a signal strength logging mode selector (not shown), the user can select the logging mode to cause the MCD 40 to initiate signal strength measurement (for example, RSSI values) and positional data logging. Alternatively, the MCD 40 can automatically initiate signal strength measurement and positional data logging. The MCD 40 can log a time stamp for each logged signal strength measurement and position. The MCD 40 can store the signal strength data, including signal strength value, positional data and time in a local storage. The MCD 40 can transmit the signal strength data in a signal strength data signal to the CSSM 90 (shown in FIGS. 2 and 3), via, for example, the transceiver site 70 (shown in FIG. 2). The signal strength data can comprise digital data packets or frames of digital data packets. The MCD 40 can transmit the signal strength data signal in real-time, intermittently, at a scheduled time, or at the request of the user.

The CSSM 90 can receive the signal strength data (SSD) signal from the MCD 40 (Step 205). The SSD signal can be demodulated and a signal strength value (SSV) and positional data can be parsed from the signal strength data (SSD) (Step 210). Additional, frequency data and/or ambient condition data can also be parsed from the signal strength data.

A target geographic area can be determined based on the positional data (Step 215). The target geographic area can be determined by the CSSM 90 by setting the positional data as a central geographic location and defining the target geographic area as comprising all locations within a predetermined radius (for example, 10 yards, 50 yards, 100 yards, or 300 yards) of the central location. Alternatively, the target geographic area can be defined or selected by a user using the MCD 40, in which case the target geographic area parameters can be received by the CSSM 90 from the MCD 40 and used to determine the target geographic area (Step 215). In this regard, the selected target geographic area can have any shape or size, depending on the user selections received by the MCD 40. Target geographic area parameters can include, for example, GPS coordinates for a plurality of points that can be used to determine an outer perimeter of the target geographic area. The target geographic area can have any shape, including, for example, a circle, a rectangle, a triangle, or a shape defined or selected by the user on the MCD 40.

Based on the target geographic area, a determination can be made whether recent SSV data and positional data exist for the area (Step 220). The determination can be made by, for example, querying the CSSM records in the database 160 (shown in FIG. 3) and analyzing the SSV data and positional data in the CSSM records associated with the locations in the target geographic area. If it is determined that recent SSV data and positional data exist for the entire area (YES at Step 220), then the SSV data and positional data is analyzed by, for example, the signal mapping unit 170 (shown in FIG. 3). The received SSV and positional data can be used by, for example, the signal mapping unit 170 to update or fine-tune parameters in the machine learning model in the embodiment that includes a neural network, as well as to update the CSSM records in the database 160 (shown in FIG. 3). Based on the results of the analysis, an optimal connectivity location can be predicted by the CSSM 90 by, for example, analyzing historical signal strength data and the received signal strength data to determine one or more locations in the target geographic area that is likely to have optimal signal strength compared to other locations in the area (Step 235). Coverage map rendering instruction and data signals can be generated and transmitted by the CSSM 90 to the MCD 40 (Step 240). The coverage map rendering instruction and data signals can include a recommended optimal connectivity location in the signal strength coverage map that can be rendered and displayed by the MCD 40 based on the received instruction and data signals.

However, if it is determined that no recent SSV data and positional data exist for the area (or a portion thereof), then a training dataset request can be generated and transmitted to the MCD 40 to acquire additional signal strength data (NO at Step 220). The transmitted training dataset request can include a message that can be rendered by the MCD 40 to request that the user move around the target geographic area to collect additional signal strength data, which can then be received by the CSSM 90 (Step 205) and Steps 210 through 220 repeated.

The terms “a,” “an,” and “the,” as used in this disclosure, means “one or more,” unless expressly specified otherwise.

The term “backbone,” as used in this disclosure, means a transmission medium that interconnects one or more computing resources to provide a path that conveys data signals and instruction signals between the one or more computing resources. The backbone can include a bus or a network. The backbone can include an Ethernet TCP/IP. The backbone can include a distributed backbone, a collapsed backbone, a parallel backbone or a serial backbone. The backbone can include any of several types of bus structures that can further interconnect to a memory bus (with or without a memory controller), a peripheral bus, and a local bus using any of a variety of commercially available bus architectures.

The term “communication device,” as used in this disclosure, means any hardware, firmware, or software that can transmit or receive data packets, instruction signals, data signals or radio frequency signals over a communication link. The communication device can include a computer or a server. The communication device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G, or 5G cellular standards, or Bluetooth. A communication link can include, for example, an RS-232, RS-422, RS-485, or any other suitable serial interface.

The terms “computer” or “computing device,” as used in this disclosure, means any machine, device, circuit, component, or module, or any system of machines, devices, circuits, components, or modules which are capable of manipulating data according to one or more instructions, such as, for example, without limitation, a processor, a microprocessor, a graphics processing unit, a central processing unit, a general purpose computer, a super computer, a personal computer, a laptop computer, a palmtop computer, a notebook computer, a desktop computer, a workstation computer, a server, a server farm, a computer cloud, or an array of processors, microprocessors, central processing units, general purpose computers, super computers, personal computers, laptop computers, palmtop computers, notebook computers, desktop computers, workstation computers, or servers.

The term “computer-readable medium,” as used in this disclosure, means any storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read. The computer-readable medium can include a “Cloud,” which includes a distribution of files across multiple (for example, thousands of) memory caches on multiple (for example, thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 802.11, DECT, 0G, 1G, 2G, 3G, 4G, or 5G cellular standards, or Bluetooth.

The term “database,” as used in this disclosure, means any combination of software or hardware, including at least one application or at least one computer. The database can include a structured collection of records or data organized according to a database model, such as, for example, but not limited to at least one of a relational model, a hierarchical model, or a network model. The database can include a database management system application (DBMS) as is known in the art. The at least one application may include, but is not limited to, for example, an application program that can accept connections to service requests from clients by sending back responses to the clients. The database can be configured to run the at least one application, often under heavy workloads, unattended, for extended periods of time with minimal human direction.

The terms “including,” “comprising” and their variations, as used in this disclosure, mean “including, but not limited to,” unless expressly specified otherwise.

The term “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, or the Internet, any of which can be configured to communicate data via a wireless or a wired communication medium. These networks can run a variety of protocols not limited to TCP/IP, IRC or HTTP.

The term “server,” as used in this disclosure, means any combination of software or hardware, including at least one application or at least one computer to perform services for connected clients as part of a client-server architecture, server-server architecture or client-client architecture. A server can include a mainframe or a server cloud or server farm. The at least one server application can include, but is not limited to, for example, an application program that can accept connections to service requests from clients by sending back responses to the clients. The server can be configured to run the at least one application, often under heavy workloads, unattended, for extended periods of time with minimal human direction. The server can include a plurality of computers configured, with the at least one application being divided among the computers depending upon the workload. For example, under light loading, the at least one application can run on a single computer. However, under heavy loading, multiple computers can be required to run the at least one application. The server, or any if its computers, can also be used as a workstation.

The terms “transmission,” “transmit,” “communication,” “communicate,” “connection,” or “connect,” as used in this disclosure, include the conveyance of data, data packets, computer instructions, or any other digital or analog information via electricity, acoustic waves, light waves or other electromagnetic emissions, such as those generated with communications in the radio frequency (RF), or infrared (IR) spectra. Transmission media for such transmissions can include subatomic particles, atomic particles, molecules (in gas, liquid, or solid form), space, or physical articles such as, for example, coaxial cables, copper wire and fiber optics, including the wires that comprise a system bus coupled to the processor.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical. In certain non-limiting embodiments, one or more process steps, method steps, or algorithms can be omitted or skipped.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications, or modifications of the disclosure.

What is claimed is:

1. A system for determining optimal placement of a communication device in a geographic area, the system comprising:
a transceiver arranged to receive signal strength data signal from a communication device located in the geographic area;
a data parser arranged to parse signal strength value data and positional data from signal strength data in the signal strength data signal;
a signal mapping unit arranged to analyze the signal strength value data and positional data and predict an optimal connectivity location in the geographic area; and
a coverage map generator arranged to generate and transmit a signal coverage map rendering instruction and data signal to the communication device.

2. The system in claim 1, wherein the signal strength value comprises a received signal strength indicator (RSSI) value that is determined by the communication device.

3. The system in claim 1, wherein the signal mapping unit comprises a neural network.

4. The system in claim 1, wherein the signal mapping unit is further arranged to analyze historical signal strength data based on the positional data.

5. The system in claim 1, further comprising:
a database arranged to store a communication signal strength mapper (CSSM) record for each positional data value.

6. The system in claim 5, wherein the positional data value comprises global positioning system (GPS) coordinates for a location in the geographic area.

7. The system in claim 1, wherein the communication device comprises a smartphone or computer tablet.

8. A method for determining a location in a geographic area for optimal connectivity or placement of a communication device, the method comprising:
receiving, by the communication device, a communication signal from a transmitting antenna;
determining, by the communication device, a signal strength value of the received communication signal at a first location in the geographic area;
determining, by the communication device, positional data for the first location;
transmitting, by the communication device, the signal strength value and positional data to a remote communication device;
receiving, by the communication device, a signal coverage map instruction and data signal from the remote communication device; and
rendering, by the communication device, a signal coverage map for the geographic area on a display device,
wherein the signal coverage map includes a predicted location in the geographic area for optimal connectivity of the communication device.

9. The method in claim 8, wherein said communication device comprises a smartphone or computer tablet.

10. The method in claim 8, wherein the signal strength value comprises a received signal strength indicator (RSSI) value measured by the communication device.

11. The method in claim 5, wherein the positional data value comprises global positioning system (GPS) coordinates for the first location in the geographic area.

12. A method for determining a location in a geographic area for optimal connectivity or placement of a communication device, the method comprising:
receiving, by a transceiver, a signal strength data signal from the communication device;
parsing, by a data parser, signal strength value data and positional data from signal strength data in the signal strength data signal;
analyzing, by a signal mapping unit, the signal strength value data and positional data;
predicting, by the signal mapping unit, the location in the geographic area for optimal connectivity of the communication device;
generating, by a coverage map generator, a signal coverage map rendering instruction and data signal; and
transmitting, by the transceiver, the signal coverage map rendering instruction and data signal to the communication device,
wherein the signal coverage map rendering instruction and data signal includes positional data for a predicted location in the geographic area for optimal connectivity of the communication device.

13. The method in claim 12, wherein said communication device comprises a smartphone or computer tablet.

14. The method in claim 12, wherein the signal strength value comprises a received signal strength indicator (RSSI) value measured by the communication device.

15. The method in claim 14, wherein the positional data value comprises global positioning system (GPS) coordinates for a location in the geographic area.

16. A non-transitory computer-readable storage medium storing computer program instructions for determining a location in a geographic area for optimal connectivity or placement of a communication device, the program instructions comprising the steps of:
receiving, by the communication device, a communication signal from a transmitting antenna;
determining, by the communication device, a signal strength value of the received communication signal at a first location in the geographic area;
determining, by the communication device, positional data for the first location;
transmitting, by the communication device, the signal strength value and positional data to a remote communication device;
receiving, by the communication device, a signal coverage map instruction and data signal from the remote communication device; and
rendering, by the communication device, a signal coverage map for the geographic area on a display device,
wherein the signal coverage map includes a predicted location in the geographic area for optimal connectivity of the communication device.

17. The storage medium in claim 16, wherein said communication device comprises a smartphone or computer tablet.

18. The storage medium in claim 16, wherein the signal strength value comprises a received signal strength indicator (RSSI) value measured by the communication device.

19. The storage medium in claim 18, wherein the positional data value comprises global positioning system (GPS) coordinates for the first location in the geographic area.

20. A non-transitory computer-readable storage medium storing computer program instructions for determining a location in a geographic area for optimal connectivity or placement of a communication device, the program instructions comprising the steps of:
receiving, by a transceiver, a signal strength data signal from the communication device;
parsing, by a data parser, signal strength value data and positional data from signal strength data in the signal strength data signal;
analyzing, by a signal mapping unit, the signal strength value data and positional data;
predicting, by the signal mapping unit, the location in the geographic area for optimal connectivity of the communication device;
generating, by a coverage map generator, a signal coverage map rendering instruction and data signal; and
transmitting, by the transceiver, the signal coverage map rendering instruction and data signal to the communication device,
wherein the signal coverage map rendering instruction and data signal includes positional data for a predicted location in the geographic area for optimal connectivity of the communication device.
